(19) United States
(12) Patent Application Publication
(10) Pub. No.: US 2010/0083913 A1
(43) Pub. Date: Apr. 8, 2010

(54) Pet step storage unit

(76) Inventor: Thomas W. Gibson, Deptford, NJ (US)

Correspondence Address: Hollstein Keating Cattell Johnson & Goldstein P.C.;Willow Ridge Executive Office Park, Suite 301, 750 Route 73 South, Marlton, NJ, 08053, US

(21) Appl. No.: 12/287,285

(22) Filed: Oct. 8, 2008

(51) Int. Cl. A01K 1/00; E04F 11/04; A01K 29/00

(52) U.S. Cl. 119/847; 312/237

(57) ABSTRACT

A pet step storage unit has a staircase with a plurality of stairs, each stair being open at its outboard lateral end and closed at its inboard lateral end. The stairs are closed off at the inboard lateral end by a planar side support which extends the length and height of the staircase. Semi-enclosed spaces are formed beneath the stairs, access to the spaces being gained through openings leading into the space. Vertical and horizontal partition components separate spaces into sectionalized storage compartments which can remain open for ready access, or which can be configured for accepting and retaining drawers.

### BACKGROUND OF THE INVENTION

This invention is directed to the field of pet staircases and, significantly, to an expansion of the functionality of staircases.

The use of staircase type units configured to allow pets to climb up to and onto beds, chairs, or similar elevated surfaces is known. Small pets, in particular, must otherwise be lifted to elevated sites. Pet staircase units allow the pet to come and go, up and down, without assistance. Such units are also especially helpful to infirmed, aged, or handicapped persons who can not lift their pets, but, for example, still wish to share the bed with them.

### SUMMARY OF THE INVENTION

The current invention thus comprises a pet staircase which not only provides an effective, well-designed means to allow pets ingress and egress to elevated surfaces, but combine this objective -with the benefit of uniquely configured and personally designed storage space, integral with the staircase.

The pet step storage unit of the present invention comprises a staircase with a plurality of stairs, each stair being open at its outboard lateral end and closed at its inboard lateral end. The stairs are closed off at the inboard lateral end by a planar side support which extends the length and height of the staircase. Semi-enclosed spaces are formed beneath the stairs, access to the spaces being gained through openings leading into the space. Vertical and horizontal partition components separate spaces into sectionalized storage compartments which can remain open for ready access, or which can be configured for accepting and retaining drawers.

The novel features which are considered as characteristic of the invention are set forth in particular in the appended claims. The invention, itself, however, both as to its design, construction and use, together with additional features and advantages thereof, are best understood upon review of the following detailed description with reference to the accompanying drawings.

### BRIEF DESCRIPTION OF THE DRAWINGS

FIG. 1 is a front isometric view of the present invention.

FIG. 2 is a rear isometric view of the present invention.

FIG. 3 is a view of the present invention in place adjacent to a bed.

### DETAILED DESCRIPTION OF THE INVENTION

Pet step storage unit 1 comprises staircase 2 with a plurality of stairs 3, 4, 5, and 6, each having top step 7, 8, 9, and 10 extending between inboard lateral ends 11, 12, 13, and 14 and outboard lateral ends 15, 16, 17 and 18 of the stairs. Lateral openings 21 lead into semi-enclosed storage spaces 20 which extend vertically downward from top step 7. Lateral openings 23 lead into semi-enclosed storage spaces 22 which extend vertically downward from step 8. Lateral openings 25 lead into semi-enclosed storage spaces 24 which extend vertically downward from step 9. Lateral opening 27 leads into semi-enclosed storage space 26 which extends vertically downward from step 10. Inboard lateral ends 11, 12, 13 and 14 of each stair are closed off-by planar side support 30, which extends substantially the full length and height of staircase 2, thereby forming the semi-enclosed spaces 20, 22, 24 and 26 beneath top steps 7, 8, 9, and 10. Access to the spaces is gained through openings 21, 23, 25, and 27. Vertical partition components 28, 29, 30 and 31 and horizontal partition components 32, 33 and 34, e.g. shelving, separate spaces 20, 22, 24 and 26 into sectionalized storage compartments, permitting convenient means for the placement and storing of clothes, shoes, toys, pet accessories, or a multitude of other different items.

In addition, pull-out drawers 35 may be configured to be inserted into any of the spaces under the steps. Storage of items can thus be fully enclosed as well.

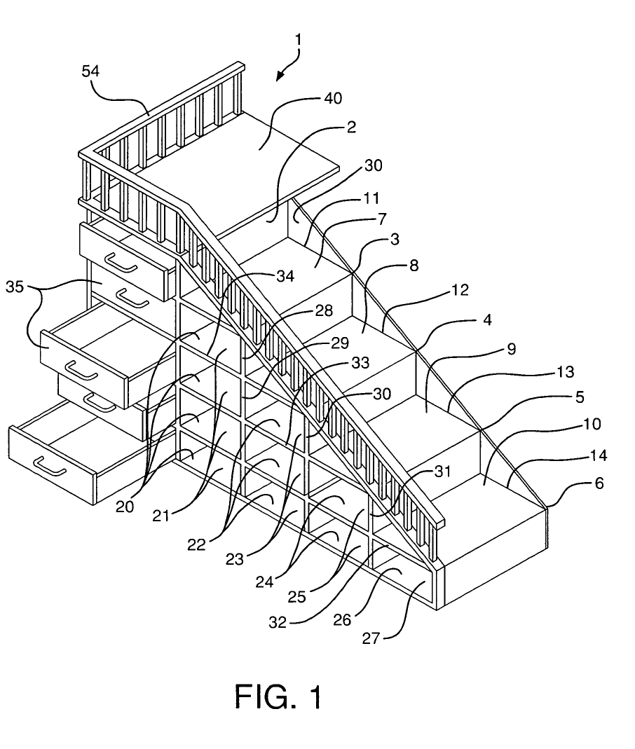

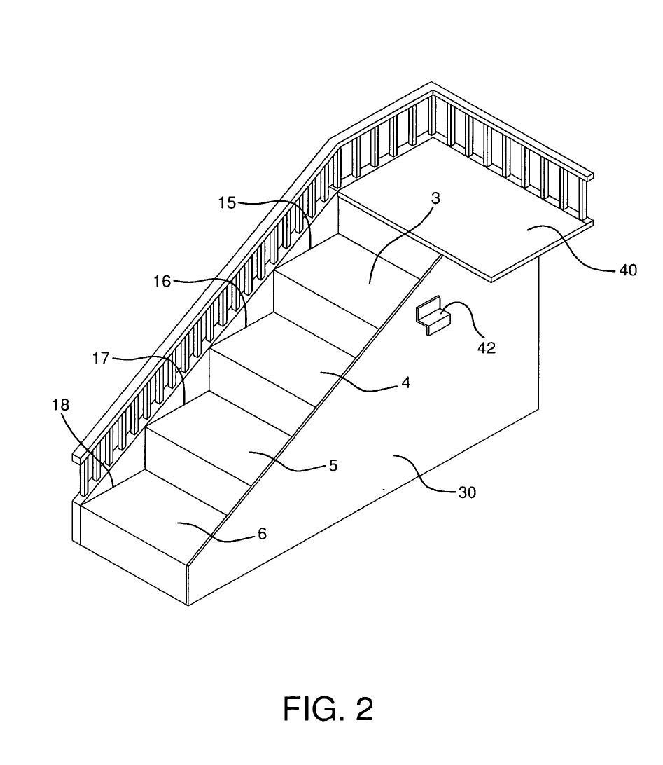

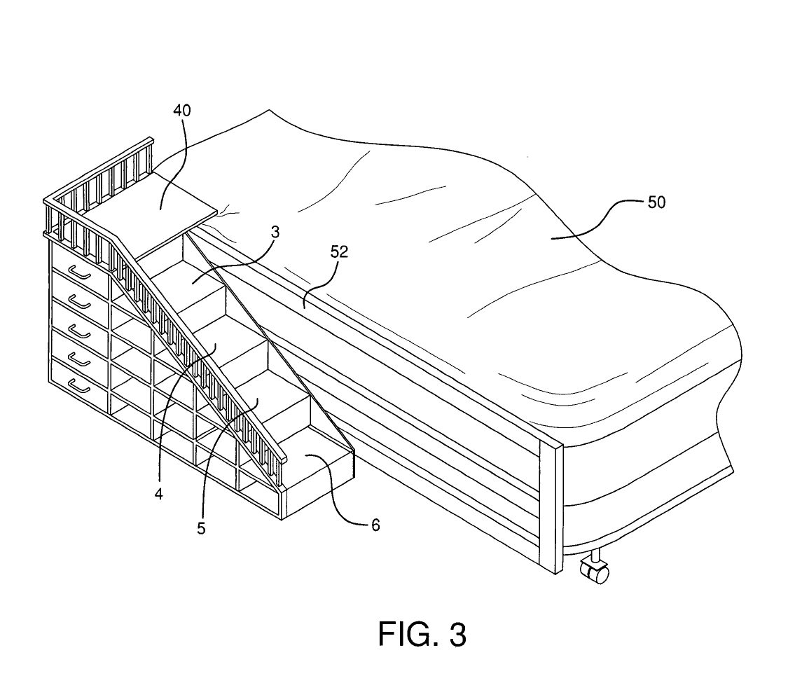

It is emphasized that the configuration of the storage compartments and drawers shown in FIGS. 1-3 represent only one functional design of the invention. It is contemplated that many different storage compartment/drawer/space configurations, including number and size of compartments and drawers, can be designed within pet step storage unit 1, depending on owner preference.

It is contemplated that the vertical height of pet step storage unit 1 will be approximately the height of bed 50, against which the unit will be placed. This will allow the pet to climb and descend stairs 3, 4, 5, and 6 and then walk over platform landing 40 extending over the uppermost step 3, directly onto or off of bed 50.

Means, in the form of bracket 42, is provided to secure pet step storage unit 1 to frame 52 of bed 50. Bracket 42 extends outward from side support 30 and is configured to simply be hooked onto frame 52, to secure unit 1 in place against bed 50. Bracket 42 can be used to attach unit 1 to other types of furniture with similarly placed frame members. Rails 54 are provided to ensure for the safety of the pet as it goes up and down staircase 2.

Thus, the present invention not only results in a convenient pet staircase which assists pets in gaining access to and in exiting off of a bed without assist, but also provides ready and convenient storage capability, adapted to be built in and converted into a variety of configurations, depending on need and use.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. A portable pet step storage unit comprising:
a staircase comprising:
a plurality of stairs, each stair having two lateral ends and a horizontally extending top step extending between the lateral ends of each stair, one lateral end of each stair comprising an opening;
planar support means extending substantially the full length of the staircase for closing off the second lateral end of each stair, thereby forming a space below the top step of each stair, each of said openings providing access to the spaces of their respective stairs;
means below the spaces for dividing the spaces into sectionalized, storage compartments; and
landing means at the upper end of the staircase to permit pet ingress onto and egress off of the staircase.

2. The portable pet step storage unit as in claim 1 comprising means to removeably attach the staircase to furniture.

3. The portable pet step storage unit as in claim 1 wherein the means for dividing the spaces comprises partitions located within the spaces under the top steps.

4. The portable pet step storage unit as in claim 4 wherein the partitions extend vertically and horizontally.

5. The portable pet step storage unit as in claim 1 further comprising drawers configured to be inserted into certain of the sectionalized storage compartments.

6. The portable pet step storage unit as in claim 1 wherein the landing means comprises a platform, outwardly extending from the top step of the staircase.

7. The portable pet step storage unit as in claim 2 wherein the means to connect comprises a bracket extending outwardly from the planar support means.
